(19) United States
(12) Patent Application Publication
(10) Pub. No.: US 2008/0172442 A1
(43) Pub. Date: Jul. 17, 2008

(54) Multi-computer system and configuration method therefor

(75) Inventors: Jung-Sheng Chen, Taipei (TW); Chih-Cheng Wei, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/653,988

(22) Filed: Jan. 17, 2007

(51) Int. Cl. G06F 15/16

(52) U.S. Cl. 709/201

(57) ABSTRACT

A multi-computer system and configuration method therefor are provided, which are suitable for use in configuring multi-computer systems into operating in combination. The respective computer system is provided with at least one processor and a plurality of electronic devices to form a computer system that can operate independently. By operating in combination, it indicates that to combine the various computer systems and their respective system resources to function and operate as a single computer system. The main feature of the method lies in connecting the various computer systems, and determining and selecting whether the computer systems operate independently or in combination by making use of a switch. In case that the combination mode is utilized, then proceed with the setting and designating of the authority of overall control of the basic input/output systems while operating in combination.

### BACKGROUND

1. Field of Invention

The invention relates to a multi-computer system and configuration method therefor, and in particular to a multi-computer system and a method therefor, that is capable of selectively controlling and configuring the multi-computer system to function independently or in combination.

2. Related Art

Nowadays, with the rapid progress and development of the information-oriented society, the data processing capacity of the data processing device, such as computer system, has been increasing rapidly, and the contents of data processing have become more complicated. As such, the computer system requires even more powerful data processing capability.

However, in recent years, the speed required for the increase of data processing capability has outpaced the speed that can be achieved in improving the processor's capability and performance.

Since the development of high performance processor is pretty time consuming, thus the improvement of processor's performance can not be realized in a rather short period of time. In this respect, the conventional main machine board having on which the processor, such as the single Central Processing Unit (CPU), is not able to meet the requirement of the present-day application of computer system. For this reason, a kind of multi-processor computer system is proposed and developed to improve the overall data processing capability of the computer system. The multi-processor computer system includes a plurality of interconnected processors, such that a data processing task can be broken down into a plurality of sub-tasks, and the workloads of data processing are shared among the respective processors in the computer system, as such the data processing capability can be improved significantly over the conventional single-processor computer. Presently, there are the existences of 2-processor and 4-processor computer systems in the industry, and tremendous efforts are underway for the research and development toward multi-processor computer system of 8 processors, or even 16 processors.

In the prior art, the configuration method of the multi-processor computer system is realized through the expansion of processor numbers. Namely, at least one processor is provided on a main machine board, and a CPU board having at least one processor thereon is coupled and connected to an expansion slot of the main machine board, so as to realize a multi-processor computer system. In the above description, the CPU board used for expanding processors is itself not a wholly integral system that can function independently, thus it must be connected to the existing main machine board to function. For this reason, although through coupling and connecting to the main machine board, the CPU board may realize the function and effectiveness of a multi-processor computer system, yet when the CPU board is not coupled and connected to the existing main machine board, the CPU board may not achieve any of its functions. Apparently, this kind of configuration may not fully utilize the hardware resources. In this regard, supposing that another main machine board is used to replace the CPU board with a single processor, so that this main machine board may function as an independent computer system even though it not being coupled and connected to the existing main machine board, as such, both of the main machine board's may be utilized to function independently as two separate computer systems. Namely, when the two main machine boards are not being connected together, the two computer system may function independently. Therefore, how to combine two of such computer systems into a multi-processor computer system capable of functioning in combination is one of the most urgent task that must be solved in this field.

### SUMMARY OF THE INVENTION

In view of the above-mentioned drawbacks and shortcomings of the prior art, the invention provides a multi-computer system and configuration method therefor. Such configuration method can be applied on two independent computer systems, thus selectively controlling and configuring each of the multi computer systems in operating independently or in combination, hereby effectively utilizing the entire system resources.

The invention disclosed a multi-computer system, including at least a first computer system and a second computer system, each having at least one processor and a plurality of electronic components, thus forming the respective computer systems that are capable of functioning independently. The technical contents and characteristics of the multi-computer system and configuration method therefor are described as follows.

When the first computer system and the second computer system are connected together by making use of a first connector and a second connector respectively, a switch provided on the first computer system may be used to determine if the first computer system and the second computer system are to be operated independently or in combination. In case that the option of operation in combination is selected; then a Complex Programmable Logic Device (CPLD) provided in the first computer system is utilized to determine the pin of the first connector connecting that switch is at low voltage potential; subsequently, a control operation is performed to bring the two computer systems into operating in combination. Moreover, the designation of the authority of overall control for the operation in combination is realized through a ROM-based Setup Utility (RBSU), and that is used to determine if the first Basic Input/Output System (BIOS) of the first computer system or the second Basic Input/Output System (BIOS) of the second computer system is given the authority to activate and initialize the operations of multi-computer system.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus is not limitative of the invention, and wherein:

FIG. 1 is a system block diagram of a multi-computer system according to an embodiment of the invention;

FIG. 2 is a schematic diagram of potential vs. time relating to the electric potential of the pins for a first connector and a second connector; and

FIG. 3 is a flowchart of the steps of a multi-computer system configuration method according to an embodiment of the invention.

### DETAILED DESCRIPTION OF THE INVENTION

The purpose, construction, features, and functions of the invention can be appreciated and understood more thoroughly through the following detailed description with reference to the attached drawings.

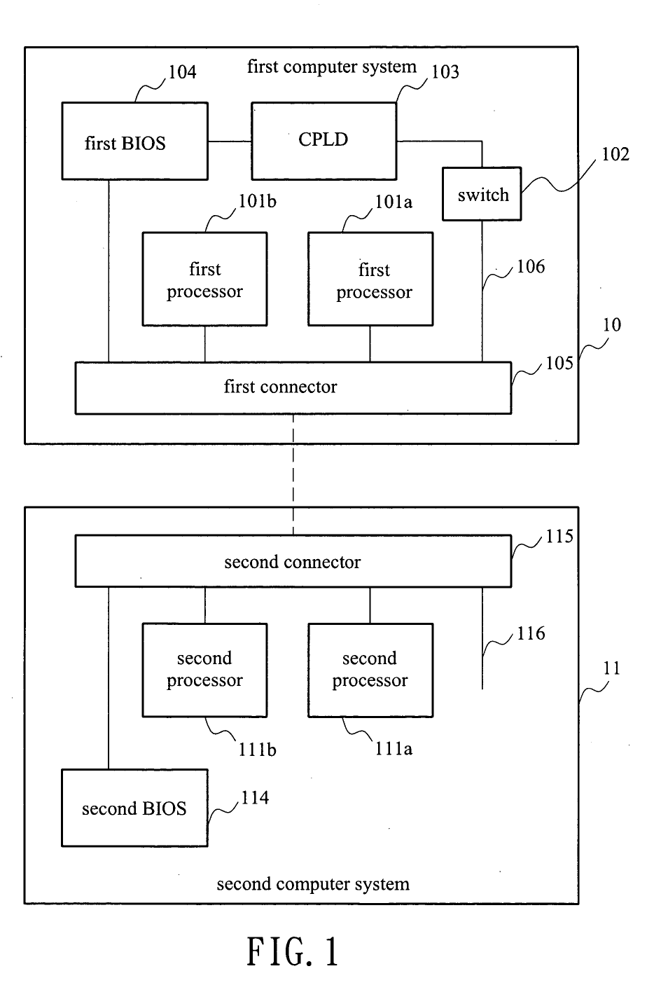

Firstly, refer to FIG. 1 for a system block diagram of a multi-computer system according to an embodiment of the invention. As shown in FIG. 1, the multi-computer system includes a first computer system 10 and a second computer system 11. Wherein, the first computer system 10 includes at least one first processor 101a and 101b, and the electronic components such as a switch 102, a CPLD 103, a first BIOS 104, and a first connector 105, thus forming a first computer system 10 that is capable of functioning independently. The connections between various electronic components are defined and realized as follows: the first processors 101a and 101b are connected to the first connector 105, the switch 102 is connected to a first pin 106 of the first connector 105, the CPLD 103 is connected to the first BIOS 104, and the first BIOS 104 is connected to the first connector 105.

Moreover, as shown in FIG. 1, the second computer system 11 includes at least one second processor 111a and 111b, and the electronic components such as a second BIOS 114, and a second connector 115 having a second pin 116, thus forming similarly a second computer system 11 that is also capable of functioning independently. The connections between various electronic components are defined and realized as follows: the second processor 111a and 111b is connected to the second connector 115, and the second connector 115 is connected to the second BIOS 114.

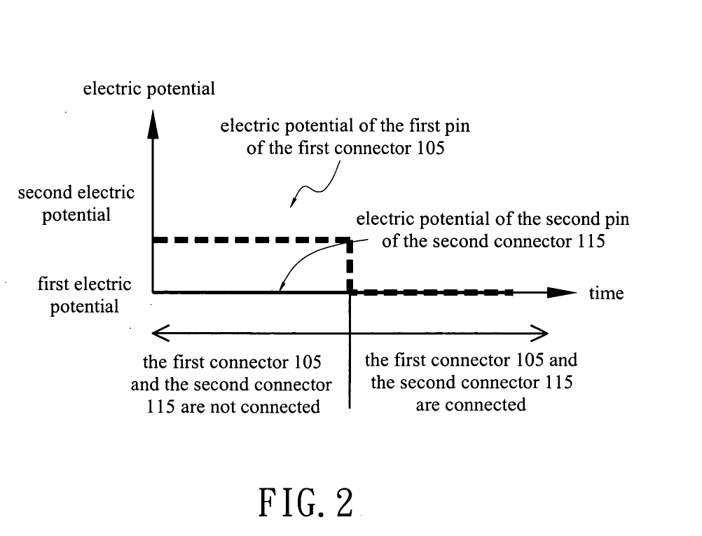

Subsequently, refer to FIG. 2 for a schematic diagram of the electric potential of the pins for a first connector 105 and a second connector 115. As shown in FIG. 2, the longitudinal axis represents electric potential, and the horizontal axis represents time. According to an embodiment of the invention, the potentials of the pins of the first connector 105 and second connector 115 are utilized to determine whether the first connector 105 and the second connector 115 are connected.

When the first connector 105 and the second connector 115 are not connected together (namely, the first computer system 10 is not connected to the second computer system 11), then the second pin 116 of the second connector 115 is at a first potential, such as a low potential or a 0 potential; while the first pin 106 of the first connector 105 is at the second potential, such as a high potential or a positive potential (as a non-limiting example, at this time, the first potential may also be a high potential or a positive potential, and the second potential may also be a low potential or a 0 potential). At this time, even if it is selected by the user that the first computer system 10 and the second computer system 11 are to operate in a combination mode and turning on the switch 102. As such, the CPLD 103 and the switch 102 are both in the ON state, and may define that the potential of the first pin 106 of the first connector 105 is at the second potential. Since, at this time, the second pin 116 of the second connector 115 is at the first potential, consequently, that indicates that the first computer system 10 and the second computer system 11 are not connected together, so that the first computer system 10 and the second computer system 11 are still both in an independent operation mode.

Furthermore, when the first connector 105 and the second connector 115 are connected together (namely, the first computer system 10 and the second computer system 11 are connected together), then the first pin 106 of the first connector 105 is at a first potential, such as a low potential or a 0 potential. At this time, if it is selected by the user that the first computer system 10 and the second computer system 11 are to operate in a combination mode and turning on the switch 102. As such, the CPLD 103 and the switch 102 are both in an ON state, thus the CPLD 103 may define the potential of the first pin 106 of the first connector 105 (namely, the first potential). Then, the CPLD 103 sends out a signal to the first BIOS 104. Upon receiving such a signal, the first BIOS 104 operates and shuts down the operations of the second BIOS 114. Moreover, as a non-limiting example, when the first computer system 10 and the second computer system 11 operate in a combination mode, it is selected and designated by the user that the first BIOS 104 is given the authority of overall control in executing the activation and initialization of the multi-computer system. Namely, the first BIOS 104 are authorized to take actions required to close down the operations of the second BIOS 114. However, the user may switch the authority of overall control of the BIOS by making use of a ROM-based Setup Utility (RBSU). As a further non-limiting example, if it is selected and designated by the user that the second BIOS 114 is given the authority of overall control of the system. Then, upon receiving a signal, the first BIOS 104 informs the second BIOS 114 to take actions to shut down the operations of the first BIOS 104. On the other hand, when the switch 102 is turned off, then the CPLD 103 and the switch 102 are both in an OFF state. At this time, though the first computer system 10 is connected to the second computer system 11, the CPLD 103 is not able to define the potential of the first pin 106 of the first connector 105. As such, the first computer system 10 and the second computer system 11 both remain in an independent operation mode.

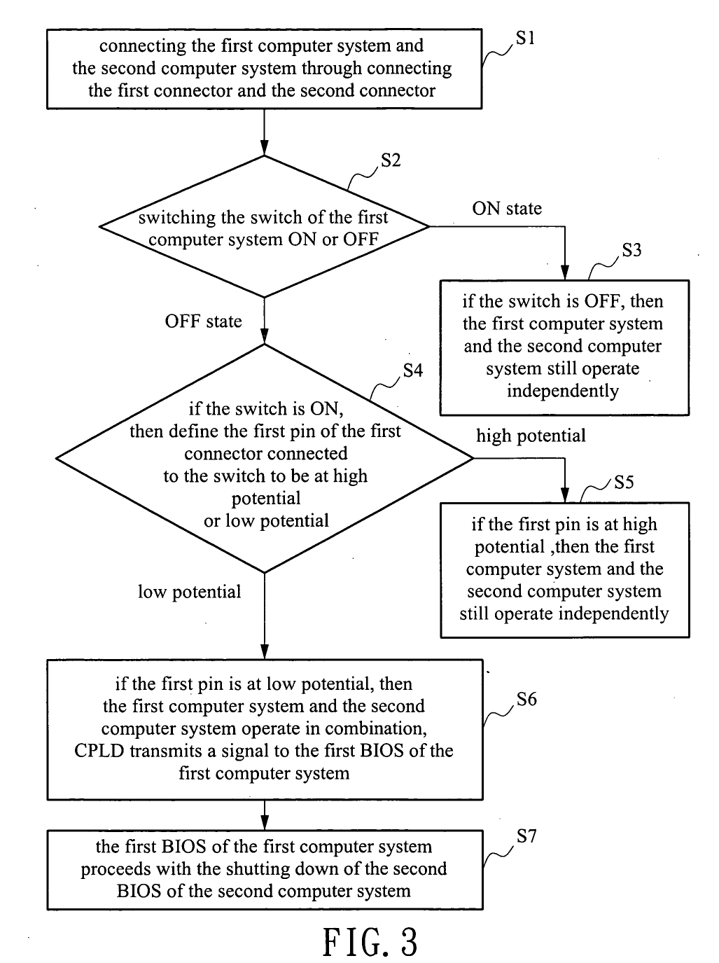

In addition, the invention discloses a multi-computer system configuration method that can be applied on the afore-mentioned first computer system 10 and second computer system 11, and is suitable for use in the operation before the start and activation of a multi-computer system. Refer to FIG. 3 for a flowchart of the steps of a multi-computer system configuration method according to an embodiment of the invention that is used to indicate the various steps of configuring the first computer system 10 and second computer system 11 according to an embodiment of the invention. At beginning, a first computer system and a second computer system are connected together by a user through utilizing a first connector and a second connector (step S1). Next, the operation mode of a multi-computer system is selected by the user by means of a switch 102. The operation mode includes an independent mode and a combination mode of the first computer system 10 and second computer system 11. In case that a combination mode is selected, then the switch 102 must be switched on, however, in case that an independent mode is selected, then the switch 102 must be switched off (step S2). Then, in case that the user selects the independent mode in operating the first computer system 10 and second computer system 11, then the switch 102 is turned off, so that the first computer system 10 and second computer system 11 operate separately as two independent systems (step S3). However, in case that the user selects the combination mode in operating the first computer system 10 and second computer system 11, then the switch 102 is turned on. At this time, the switch 102 and the CPLD 103 are both turned on, thus the CPLD 103 is utilized to determine whether the first pin 106 is at the first potential or the second potential (step S4). If the first pin 106 is at the second potential, then the first computer system 10 and second computer system 11 still operate separately as two independent systems (step S5). If the first pin 106 is at the first potential/low potential, then the first computer system 10 and the second computer system 11 proceed with their operations in combination. At this time, the CPLD 103 transmits a signal to the first BIOS 104 of the first computer system 10 (step S6). And finally, the first BIOS 104 of the first computer system 10 takes actions to shut down the operations of the second BIOS 114 of the second computer system 11 (step S7).

Through the application of the multi-computer system configuration method of the invention, when two computer systems are connected together, the two computer systems may be configured as a single computer system, or two independent computer systems. In case that it is configured to a single computer system, then the various electronic components of the two computer systems are combined to perform as a single computer system. Thus the configured single computer system is provided with more processors than either the first computer system 10 or the second computer system 11, hereby enhancing the efficiency of data processing.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multi-computer system, comprising:
a first computer system, having a first connector and a first basic input/output system (BIOS), wherein said first connector is provided with a first pin at a second potential;
a second computer system, having a second connector and a second BIOS that can be connected to said first connector, wherein said second connector has a second pin at a first potential, when said first connector is connected to said second connector, said first pin is electrically connected to said second pin, so that potential at said first pin and potential at said second pin become said same first potential;
a switch, connected to said first pin of said first connector, and is used to selectively set an operation mode of said multi-computer system; and
a complex programmable logic device (CPLD), connected between said switch and said first BIOS in series, and used to determine operation mode based on potential transmitted from said switch;
wherein, when said multi-computer system is set to operate in a combination mode, then said CPLD and said switch are both turned on, and said first connector and said second connector are connected, such that potential of said first pin becomes said first potential, thus said CPLD sends out a signal informing said first BIOS of said first computer system to shut down operations of said second BIOS of said second computer system.

2. The multi-computer system as claimed in claim 1, wherein a user designates and sets authority of overall control of said first BIOS and said second BIOS through a ROM-based setup utility (RBSU).

3. The multi-computer system as claimed in claim 2, wherein in case that said user sets and designates that said second BIOS as having authority of overall control, then said second BIOS proceeds to shut down said first BIOS.

4. A configuration method for multi-computer system, said multi-computer system including a first computer system and a second computer system that are capable of operating independently, and said first computer system and said second computer system connected to each other through a first connector and a second connector, said configuration method comprising following steps:
selectively setting an operation mode of said multi-computer system by making use of a switch;
turning on both said switch and a complex programmable logic device (CPLD) when selected operation mode is a combination mode concerning said first computer system and said second computer system;
defining potential of a first pin of said first connector connected to said switch by means of said CPLD;
operating in combination of both said first computer system and said second computer system when said first pin is at a first potential, thus said CPLD transmits a signal to a first basic input/output system (BIOS) of said first computer system; and
shutting down operations of a second BIOS of said second computer system through said first BIOS of said first computer system.

5. The configuration method for multi-computer system as claimed in claim 4, wherein when said first connector and said second connector are not connected, a second pin of said second connector is at said first potential, and said first pin of said first connector is at a second potential.

6. The configuration method for multi-computer system as claimed in claim 5, wherein when said first connector and said second connector are connected together, potential of said first pin of said first connector is changed from said second potential to said first potential.

7. The configuration method for multi-computer system as claimed in claim 4, wherein in case that said operation mode is said combination mode concerning said first computer system and said second computer system, and when said first pin of said first connector is at said second potential, then said first computer system and said second computer system still operate independently.

8. The configuration method for multi-computer system as claimed in claim 4, wherein a user designates and sets authority of overall control of said first BIOS and said second BIOS through a ROM-based setup utility (RBSU).

9. The configuration method for multi-computer system as claimed in claim 8, wherein in case that said user sets and designates that said second BIOS as having authority of overall control, then said second BIOS proceeds to shut down operations of said first BIOS.
